(19) United States
(12) Patent Application Publication
(10) Pub. No.: US 2024/0362362 A1
(43) Pub. Date: Oct. 31, 2024

(54) TRAINING DATA MANAGEMENT DEVICE, TRAINING DATA MANAGEMENT METHOD, AND NON-TRANSITORY COMPUTER READABLE MEDIUM

(71) Applicant: FUJIFILM Corporation, Tokyo (JP)

(72) Inventor: Takahiro KANEDA, Tokyo (JP)

(73) Assignee: FUJIFILM Corporation, Tokyo (JP)

(21) Appl. No.: 18/645,328

(22) Filed: Apr. 24, 2024

(30) Foreign Application Priority Data
Apr. 25, 2023 (JP) 2023-071811

(51) Int. Cl. G06F 21/62

(52) U.S. Cl. CPC G06F 21/6254

(57) ABSTRACT

A training data management device includes a processor, in which the processor stores, in a data storage unit, training data in which examination data and diagnostic data generated based on the examination data are included in association with each other, deletes specific examination data from the data storage unit, specifies the diagnostic data associated with the deleted examination data, generates pseudo examination data, which is pseudo for the deleted examination data, based on the specified diagnostic data, and stores the pseudo examination data in the data storage unit in association with the specified diagnostic data.

### CROSS-REFERENCE TO RELATED APPLICATIONS

This application claims priority under 35 U.S.C § 119 (a) to Japanese Patent Application No. 2023-071811 filed on 25 Apr. 2023. The above application is hereby expressly incorporated by reference, in its entirety, into the present application.

### BACKGROUND OF THE INVENTION

### 1. Field of the Invention

The present invention relates to a training data management device, a training data management method, and a non-transitory computer readable medium.

### 2. Description of the Related Art

In recent years, in the medical field, a technique of machine learning using various medical data obtained in medical care has been developed. However, since the medical data as described above may include personal information, it is studied to safely handle the medical data used for machine learning from the viewpoint of personal information protection.

For example, a provision device is disclosed, which stores patient information and medical treatment information from a patient in a distributed manner and provides the patient information and the medical treatment information to a third party together with consent information of the patient (JP2022-143911A, corresponding to US2023/410963A1).

### SUMMARY OF THE INVENTION

From the viewpoint of personal information protection, even in a case where the personal information is provided for various uses with the consent from the individual, the provision of the personal information can be withdrawn by the expression of intention of the individual (opt-out). In this case, it is necessary to not use this personal information after the intention to withdraw the provision is expressed.

However, in a case where data for which the provision is withdrawn is deleted, for example, in a case where data including the personal information is used as training data for a learning model, the stability of the quality of the training data may be impaired. There is a concern that the accuracy of the learning model or the like using the training data is deteriorated due to the impairment of the stability of the quality of the training data.

An object of the present invention is to provide a training data management device, a training data management method, and a non-transitory computer readable medium which can delete specific data while maintaining safety of training data and stability of a quality of the training data.

An aspect of the present invention relates to a training data management device comprising: a processor, in which the processor stores, in a data storage unit, training data in which examination data obtained from an examination got by an individual and diagnostic data generated based on the examination data are included in association with each other, deletes specific examination data from the data storage unit, specifies the diagnostic data associated with the deleted examination data, generates pseudo examination data, which is pseudo for the deleted examination data, based on the specified diagnostic data, and stores the pseudo examination data in the data storage unit in association with the specified diagnostic data.

It is preferable that the specific examination data is the examination data including a content indicating that consent to provide information is withdrawn from the individual.

It is preferable that the pseudo examination data is the examination data having the same feature as a feature of the deleted examination data.

It is preferable that the pseudo examination data is the examination data that does not completely match the deleted examination data.

It is preferable that the data storage unit associates a personal ID and the examination data of the individual who gets the examination with each other using a first pseudonym ID and associates the first pseudonym ID and the diagnostic data with each other using a second pseudonym ID, to store the training data in which the personal ID, the examination data, and the diagnostic data are included in association with each other.

It is preferable that the processor generates a pseudonym reverse lookup table consisting of the personal ID and the first pseudonym ID, a pseudonym examination table consisting of the first pseudonym ID and the examination data, an examination diagnosis reverse lookup table consisting of the first pseudonym ID and the second pseudonym ID, and a pseudonym diagnosis table consisting of the second pseudonym ID and the diagnostic data, and the data storage unit stores the pseudonym reverse lookup table, the pseudonym examination table, the examination diagnosis reverse lookup table, and the pseudonym diagnosis table in the data storage unit.

It is preferable that, in a case where the processor deletes the examination data of a specific individual from the data storage unit, the processor deletes the personal ID of the specific individual and a specific first pseudonym ID associated with the personal ID in the pseudonym reverse lookup table, the specific first pseudonym ID and specific examination data associated with the specific first pseudonym ID in the pseudonym examination table, and the specific first pseudonym ID and a specific second pseudonym ID associated with the specific first pseudonym ID in the examination diagnosis reverse lookup table.

It is preferable that the processor generates the pseudo examination data by using a pseudo examination data generation model, and the pseudo examination data generation model is a trained model that has been trained to generate the pseudo examination data by receiving input of the deleted examination data and the diagnostic data.

It is preferable that the processor calculates a reconstruction error indicating a rate of match between the deleted examination data and the pseudo examination data, and the pseudo examination data generation model generates the pseudo examination data such that an absolute value of the reconstruction error is a positive number.

It is preferable that the pseudo examination data generation model is a model in which a generation model that generates the pseudo examination data by receiving the input of the deleted examination data and the diagnostic data, and an evaluation model that evaluates the generated pseudo examination data are connected to each other.

Another aspect of the present invention relates to a training data management method comprising: a step of storing, in a data storage unit, training data in which examination data and diagnostic data generated based on the examination data are included in association with each other; a step of deleting specific examination data from the data storage unit; a step of specifying the diagnostic data associated with the deleted examination data; a step of generating pseudo examination data, which is pseudo for the deleted examination data, based on the specified diagnostic data; and a step of storing the pseudo examination data in the data storage unit in association with the specified diagnostic data.

Still another aspect of the present invention relates to a non-transitory computer readable medium storing a computer-executable program causing a computer to execute: a function of storing, in a data storage unit, training data in which examination data and diagnostic data generated based on the examination data are included in association with each other; a function of deleting specific examination data from the data storage unit; a function of specifying the diagnostic data associated with the deleted examination data; a function of generating pseudo examination data, which is pseudo for the deleted examination data, based on the specified diagnostic data; and a function of storing the pseudo examination data in the data storage unit in association with the specified diagnostic data.

According to the aspects of the present invention, it is possible to delete the specific data while maintaining the safety of the training data and the stability of the quality of the training data.

### BRIEF DESCRIPTION OF THE DRAWINGS

FIG. 1 is a block diagram showing a function of a training data management device.

FIG. 2 is a diagram showing a configuration of a medical treatment information management system including the training data management device.

FIG. 3 is a diagram showing various tables included in a data storage unit.

FIG. 4 is a diagram showing contents of a pseudonym reverse lookup table.

FIG. 5 is a diagram showing contents of a pseudonym examination table.

FIG. 6 is a diagram showing contents of an examination diagnosis reverse lookup table.

FIG. 7 is a diagram showing contents of a pseudonym diagnosis table.

FIG. 8 is a diagram showing deletion of examination data.

FIG. 9 is a block diagram showing a function of a pseudo examination data generation unit.

FIG. 10 is a diagram showing a function of a pseudo examination data generation unit.

FIG. 11 is a diagram showing a function of a reconstruction accuracy suppression unit.

FIG. 12 is a flowchart showing a flow of processing in the training data management device.

### DESCRIPTION OF THE PREFERRED EMBODIMENTS

An example of embodiments of a training data management device and the like of the present invention will be described. First, a description will be made of how one form of the following embodiment is obtained. In a case where a medical learning model using a machine learning technique is generated, the medical learning model is generated using examination data of an individual and diagnostic data based on the examination data as training data.

From the viewpoint of personal information protection, the provision of the personal information that is once provided can be withdrawn by the expression of an intention of a provider (opt-out). In this case, data including the corresponding personal information should be deleted from the accumulated training data, and as a result, the accuracy of the learning model trained by the training data may be deteriorated.

Therefore, in the present invention, the training data management device and the like are provided, which can delete specific data while maintaining stability of a quality of the training data without a deterioration of the quality of training data, which leads to a deterioration in the accuracy of the learning model and the like.

With the training data management device and the like according to the embodiment of the present invention, the examination data is generated in a pseudo manner from diagnostic information associated with the examination data including the personal information to be deleted, and the pseudo examination data is used as dummy data instead of the examination data which is the deleted personal information. Through the training using the dummy data instead of the deleted personal information, it is possible to minimize the deterioration in quality of the learning model.

In the present specification, a case of one data, a case of a plurality of data, and a case of a data set are included in a case of the training data, the examination data, or the diagnostic data. It should be noted that, in the present embodiment, the medical data, for example, the examination data or the diagnostic data is used as the training data, but the present invention is not limited to this, and data other than the medical data can be used. For example, the present invention can also be applied to training data or the like including data related to finance that handles personal information of a customer. In the present specification, the “learning model” may include a trained model.

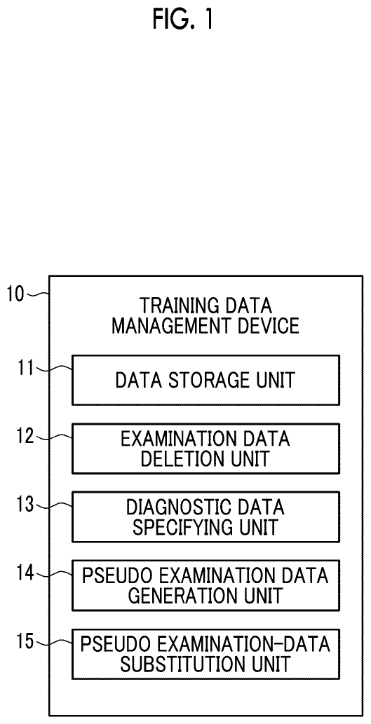

The training data management device according to the embodiment of the present invention is a device that manages the training data used for machine learning. As shown in FIG. 1, a training data management device 10 comprises a data storage unit 11, an examination data deletion unit 12, a diagnostic data specifying unit 13, pseudo examination data generation unit 14, and a pseudo examination data substitution unit 15.

The data storage unit 11 stores training data in which examination data and diagnostic data generated based on the examination data are included in association with each other. It is preferable that the examination data and the diagnostic data be stored independently. As a result, it is possible to perform editing, such as deletion, on each data. In this case, it is preferable to associate both data by providing another data for associating the examination data with the diagnostic data.

The examination data is data including the results of various tests obtained by the individual getting the examinations and the like, and generally referred to as health check-up data. The diagnostic data is data including a diagnosis result diagnosed by a doctor based on the examination data or the like. The training data is a data set labeled with a correct answer, which is used for learning using a learning model that is a machine learning algorithm. For the examination data, the correct answer label is the diagnostic data diagnosed by the doctor based on the examination data. Therefore, the training data is a data set in which the examination data obtained by the examination and the diagnostic data generated based on the examination data are included in association with each other.

The training data need only be data that can be used for training the learning model. It is preferable that the training data is training data for allowing learning such that, in a case where the examination data of which the diagnostic data is unknown is input to a trained model obtained by training a learning model using the training data, the diagnostic data, which is the correct answer corresponding to the examination data, is output.

The examination data deletion unit 12 deletes specific examination data from the data storage unit 11. A user designates the examination data desired to be deleted from the data storage unit 11, and the designated examination data is set as the specific examination data. In the examination data stored in the data storage unit 11, there may be the examination data desired to be deleted due to the reason that the consent to provide information about the examination data is withdrawn from the individual who gets the examination which is a source of the examination data. For example, in a case where the training data including the examination data stored in the data storage unit 11 is used after the consent is withdrawn, it is necessary to delete the examination data for which the consent to provide information is withdrawn, from the data storage unit 11 before using the training data.

The diagnostic data specifying unit 13 specifies the diagnostic data associated with the deleted examination data. Since the examination data and the diagnostic data are associated with each other, the diagnostic data associated with the examination data can be specified from the deleted examination data. The pseudo examination data generation unit 14 uses the specified diagnostic data.

The pseudo examination data generation unit 14 generates the pseudo examination data that is pseudo for the deleted examination data based on the specified diagnostic data. The pseudo examination data that is pseudo for the deleted examination data means data different from the deleted examination data but has properties, features, and the like similar to those of the deleted examination data. The properties, the features, and the like are the properties, the features, and the like as the training data. The properties, the features, and the like are similar to those of the deleted examination data, a difference in the obtained trained model is small between a case where the pseudo examination data is used as the training data and a case where the deleted examination data is used as the training data. That is, it is preferable that, in a case where the learning model is trained by using each of the training data including the deleted examination data and the training data including the pseudo examination data, the pseudo examination data that is pseudo for the deleted examination data is similar pseudo examination data such that it is difficult to distinguish which training data is used, from a result output by the trained model.

As described above, it is preferable that the pseudo examination data is the examination data having the same feature as the feature of the deleted examination data. Specifically, the feature in this case is, for example, a distribution, a tendency, or a statistical feature of the data, and it is preferable that the deleted examination data and the pseudo examination data have the similar distribution, tendency, or statistical feature of the data.

It is preferable that the pseudo examination data is data that does not completely match the deleted examination data. In a case where the pseudo examination data that is pseudo for the deleted examination data is data that completely matches the deleted examination data, there is a concern that the distinction from the examination data desired to be deleted cannot be made and the examination data is deleted. There is a case where an individual can be specified by a unique feature of the examination data itself. Since the pseudo examination data is data that does not completely match the deleted examination data, it is possible to make it clear that the examination data desired to be deleted is deleted.

It should be noted that the data that does not completely match is data in which all values and the like match between the deleted examination data and the pseudo examination data in a case where the specific examination data is data including a plurality of values and the like. Therefore, the pseudo examination data may partially match the deleted examination data.

As described above, since the deleted examination data and the pseudo examination data have the same feature, in the trained model in which each learning model is trained by the training data before the specific examination data is deleted and the training data obtained by deleting the specific examination data and including the pseudo examination data, it is difficult to distinguish which training data is used, from a result output by the trained model. Therefore, even in a case where the training data including the pseudo examination data is used for the learning, it is possible to maintain the quality of the trained model, the quality of such training data is minimized, and thus the stability of the quality is maintained.

A pseudo examination data generation model that is a generation model can be used to generate the pseudo examination data. The pseudo examination data generation model is a trained generation model that has been trained to output the pseudo examination data by receiving input of the deleted examination data and the diagnostic data generated based on the examination data. Preferably, the pseudo examination data generation model is trained to output the pseudo examination data that does not completely match the deleted examination data, but is pseudo for the examination data. Therefore, the pseudo examination data generation model has a function of restoring the examination data similar to the input examination data.

Any learning model may be adopted as the pseudo examination data generation model as long as the pseudo examination data that is pseudo for the examination data can be output, and any one of a learning model for supervised learning or a learning model for unsupervised learning may be used. It is preferable to use a neural network (NN) model as the pseudo examination data generation model in terms of excellent pseudo examination data to be generated. It is more preferable to use a deep neural network (DNN) which is a deep network structure having a large number of hidden layers.

In addition, as the configuration of the learning model of the pseudo examination data generation model, since the pseudo examination data generation model can be preferably created by applying the data that is pseudo for the input examination data to the diagnostic data that is the correct answer label, a generation model, such as conditional generative adversarial networks (conditional GAN) classified into a supervised learning model having a generator and a discriminator or conditional variational autoencoders (conditional VAE) classified into a supervised learning model, may be used.

The pseudo examination data substitution unit 15 stores the pseudo examination data in the data storage unit 11 in association with the specific diagnostic data associated with the deleted examination data. That is, the pseudo examination data substitution unit 15 stores the pseudo examination data generated by the pseudo examination data generation unit 14 in the data storage unit 11 in association with the specific diagnostic data, as a substitute for the deleted examination data. Therefore, after the specific examination data is deleted, the pseudo examination data and the diagnostic data associated with the pseudo examination data are formed into the training data to substitute the deleted examination data and the diagnostic data corresponding to the deleted examination data, and the formed training data is stored in the data storage unit 11.

As described above, since the training data management device 10 can delete any specific data in the training data stored in the data storage unit 11, the training data does not include inappropriate data, and the safety of the training data can be maintained. In addition, even in a case where the specific data is deleted, since the pseudo examination data having similar properties, features, and the like can be generated and used instead of the deleted data, the stability of the quality of the training data is maintained. Therefore, the training data management device 10 can delete the specific data while maintaining the safety of the training data and the stability of the quality of the training data.

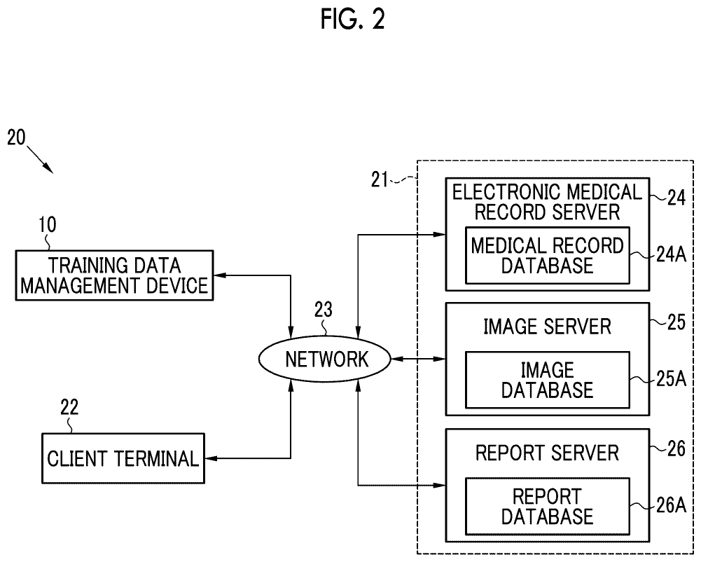

Hereinafter, an example of the embodiment of a training data management device 10 and the like will be described with reference to the drawings. As shown in FIG. 2, the medical treatment information management system 20 is a computer system that manages medical treatment information in a medical institution such as a hospital. The medical treatment information management system 20 comprises the training data management device 10, a server group 21, and a client terminal 22, which are communicably connected via a network 23.

It is preferable that the training data management device 10 is installed in the medical institution as shown in FIG. 2 from the viewpoint of managing personal information. In this case, the network 23 is a local area network (LAN) or the like laid in the medical institution. It should be noted that the training data management device 10 may be installed outside the medical institution as long as it is possible to appropriately manage the personal information.

The training data management device 10 is configured by installing an operating system program and an application program, such as a client program, on a computer comprising a processor as a base. The training data management device 10 stores a training data management program in a storage (not shown) in addition to an operating system and the like.

The training data management program is an application program causing a computer constituting the training data management device 10 to execute functions as the training data management device 10. In a case where the training data management device 10 is activated, a processor (not shown) provided in the training data management device 10 executes the training data management program in cooperation with a memory (not shown) to function as the data storage unit 11, the examination data deletion unit 12, the diagnostic data specifying unit 13, the pseudo examination data generation unit 14, the pseudo examination data substitution unit 15, and the like.

The server group 21 provides the examination data and the like to the training data management device 10. The server group 21 includes an electronic medical record server 24, an image server 25, a report server 26, and the like.

The electronic medical record server 24 includes a medical record database 24A that stores an electronic medical record. The electronic medical record is a set of one or a plurality of medical treatment data. Specifically, the electronic medical record includes the examination data and the diagnostic data generated based on the examination data. Additionally, medical treatment data, such as medical examination records, sampling test results, vital signs of the patient, orders of tests, treatment records, and accounting data, are included.

The image server 25 is a so-called picture archiving and communication system (PACS) server, and includes an image database 25A in which medical images are stored. The medical images are images obtained by various image tests such as a CT test, an MRI test, an X-ray test, an ultrasound test, and an endoscopy. These medical images are recorded in a format conforming to, for example, a digital imaging and communications in medicine (DICOM) standard.

The report server 26 includes a report database 26A that stores medical reports such as interpretation reports. The medical reports include the interpretation report and a precision test report, and are reports that summarize images, numerical values, and findings obtained in tests such as an image test and a sampling test. The interpretation of the medical image and the creation of the interpretation report are performed by a radiologist.

The client terminal 22 is a computer (including a tablet terminal and the like) or the like directly operated by medical staff such as a doctor, a test technician, or a nurse. The client terminal 22 can perform an operation for various servers of the server group 21 and an operation for the training data management device 10. The doctor can access the server group 21 by using the client terminal 22, confirm the examination data, and store the diagnostic data generated based on the examination data in the training data management device 10. The examination data stored in the data storage unit 11 of the training data management device 10 and desired to be deleted can be specified and an instruction of the deletion can be given.

Each of the electronic medical record, the medical image, and the report is attached with a personal identifier (ID) given to each patient. In addition, the training data management device 10 may obtain various types of information obtained by analyzing various types of data obtained from the electronic medical record server 24, the image server 25, the report server 26, and the like by a medical treatment support device or the like (not shown), a result of the diagnosis by the doctor based on these information, and the like, as the examination data or the diagnostic data. For example, the training data management device 10 may obtain various test results obtained by analyzing the CT test image obtained from the image server 25 by the medical treatment support device as the examination data, and may obtain the diagnostic data generated by the doctor diagnosing based on the test result by using the client terminal 22.

The training data management device 10 stores, in the data storage unit 11, the training data in which the examination data obtained by the examination got by the individual and obtained from the server group 21, and the diagnostic data generated based on the examination data are included in association with each other.

Preferably, the data storage unit 11 stores the training data in an aspect in which the personal ID and the examination data of the individual who gets the examination are associated with each other using a first pseudonym ID, and the first pseudonym ID and the diagnostic data are associated with each other using a second pseudonym ID.

It is preferable that the data storage unit 11 stores these data in a plurality of tables or databases. The table is a structure that stores and organizes relevant data in a table form, and stores data in a table form consisting of rows and columns. The database may include a plurality of tables, and may store a relationship among the plurality of tables in some cases. Since the data storage unit 11 easily deletes the data, it is more preferable to store these data by a table.

It is preferable that the data storage unit 11 stores the personal ID, the examination data, and the diagnostic data in separate tables, respectively. It is preferable that, even in a case where the personal ID, the examination data, and the diagnostic data are stored in separate tables, the personal ID, the examination data, and the diagnostic data are stored so that the reverse lookup and tracing back are possible from the personal ID by using the first pseudonym ID and the second pseudonym ID. In addition, by storing each data as an individual table, even in a case where any of the individual tables is leaked, it is impossible to directly obtain the examination data and/or the diagnostic data from the personal ID, and vice versa, so that it is possible to maintain the safety from the viewpoint of personal information protection.

The data storage unit 11 preferably generates a pseudonym reverse lookup table consisting of the personal ID and the first pseudonym ID, a pseudonym examination table consisting of the first pseudonym ID and the examination data, an examination diagnosis reverse lookup table consisting of the first pseudonym ID and the second pseudonym ID, and a pseudonym diagnosis table consisting of the second pseudonym ID and the diagnostic data.

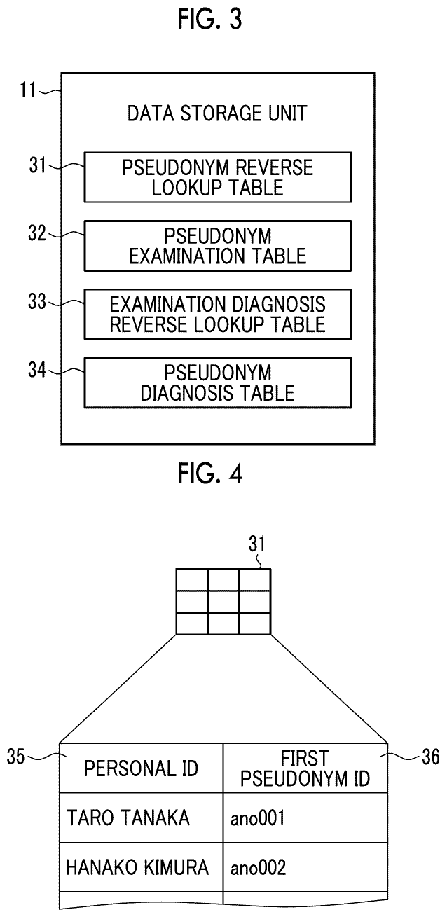

Specifically, as shown in FIG. 3, it is preferable that the data storage unit 11 comprises a pseudonym reverse lookup table 31 in which the personal ID and the first pseudonym ID arc associated with each other, a pseudonym examination table 32 in which the first pseudonym ID and specific measurement data, which is the examination data, are associated with each other, an examination diagnosis reverse lookup table 33 in which the first pseudonym ID and the second pseudonym ID are associated with each other, and a pseudonym diagnosis table 34 in which the second pseudonym ID and the diagnostic data, which is a result of the diagnosis by the doctor from the examination data are associated with each other. With these tables, as described above, in the training data, the personal ID and the examination data of the individual who gets the medical examination are associated with each other using the first pseudonym ID, and the first pseudonym ID and the diagnostic data are associated with each other using the second pseudonym ID.

As shown in FIG. 4, the pseudonym reverse lookup table 31 is data in which a personal ID 35 and a first pseudonym ID 36 are associated with each other. In FIG. 4, “Taro Tanaka” as the personal ID 35 and “ano001” as the first pseudonym ID 36 are associated with each other, and similarly, “Hanako Kimura” as the personal ID 35 and “ano002” as the first pseudonym ID 36 are associated with each other.

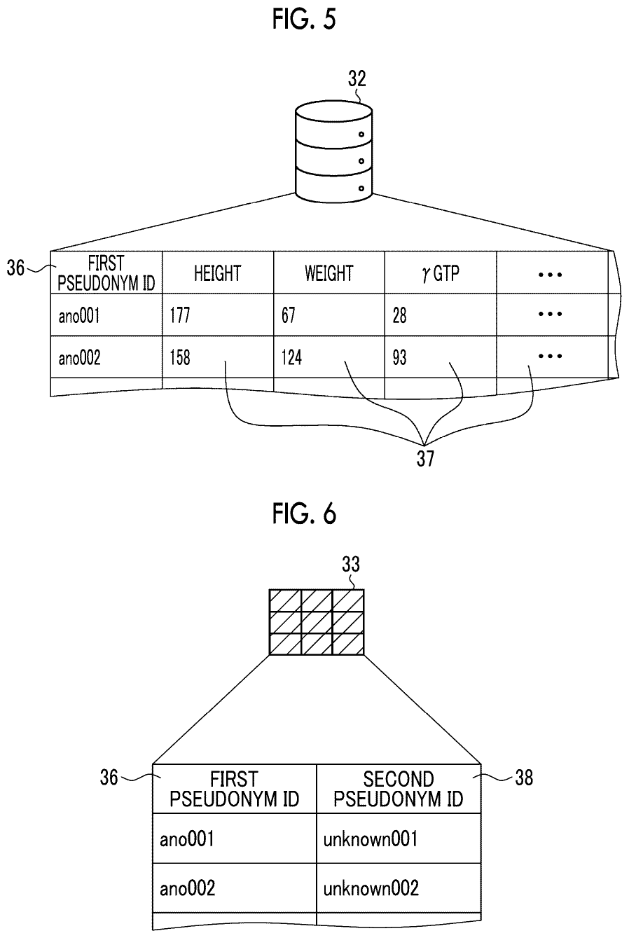

As shown in FIG. 5, the pseudonym examination table 32 is data in which the first pseudonym ID 36 and examination data 37, which is specific measurement data, are associated with each other. In FIG. 5, “ano001” as the first pseudonym ID 36 and “height: 177, weight: 67, γGTP: 28, and the like” as the examination data 37 are associated with each other, and similarly, “ano002” as the first pseudonym ID 36 and “height: 158, weight: 124, γGTP: 93, and the like” as the examination data 37 are associated with each other.

As shown in FIG. 6, the examination diagnosis reverse lookup table 33 is data in which the first pseudonym ID 36 and a second pseudonym ID 38 are associated with each other. In FIG. 6, “ano001” as the first pseudonym ID 36 and “unknown001” as the second pseudonym ID 38 are associated with each other, and similarly, “ano002” as the first pseudonym ID 36 and “unknown002” as the second pseudonym ID 38 are associated with each other.

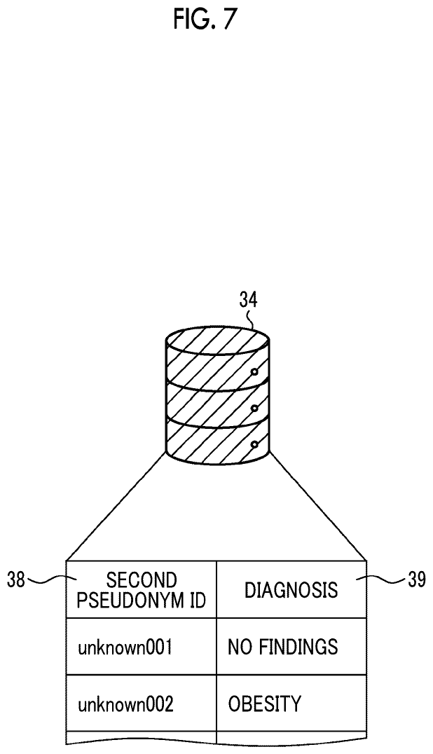

As shown in FIG. 7, the examination diagnosis reverse lookup table 33 is data in which the second pseudonym ID 38 and diagnostic data 39 are associated with each other. In FIG. 7, “unknown001” as the second pseudonym ID 38 and “no findings” as the diagnostic data 39 are associated with each other, and similarly, “unknown002” as the second pseudonym ID 38 and “obesity” as the diagnostic data 39 are associated with each other.

The examination data 37 stored as described above is used for various uses, and the consent to provide information about the examination data 37 is acquired from the individual who gets the examination. Even in a case where the individual consents to provide information about the examination data 37, the individual can withdraw the consent to provide information. After the consent is withdrawn, the examination data 37 of the individual who withdraws the consent cannot be used. Therefore, it is necessary to delete the examination data 37 of the individual who withdraws the consent from the data storage unit 11. Even in a case where the individual does not withdraw the consent to provide information, it is considered that the individual may want to perform editing such as deleting the examination data 37 or the diagnostic data 39 in order to obtain more preferable training data.

In a case where the examination data 37 of a specific individual from the data storage unit 11 is deleted, the examination data deletion unit 12 deletes the personal ID 35 of the specific individual and the specific first pseudonym ID 36 associated with the personal ID 35 in the pseudonym reverse lookup table 31, the specific first pseudonym ID 36 and the specific examination data 37 associated with the specific first pseudonym ID 36 in the pseudonym examination table 32, and the specific first pseudonym ID 36 and the specific second pseudonym ID 38 associated with the specific first pseudonym ID 36 in the examination diagnosis reverse lookup table 33. As a result, the examination data 37 of the individual who withdraws the consent to provide information is deleted. In addition, the association between the diagnostic data 39 and the personal ID 35 can be released, and the diagnostic data 39 can be anonymized and left such that the specific individual cannot be identified.

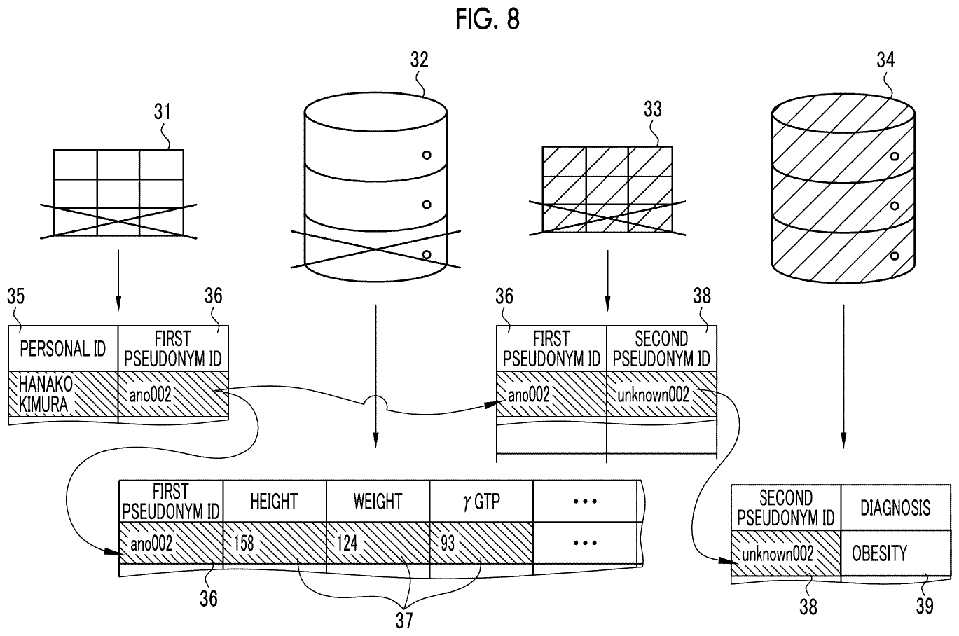

As shown in FIG. 8, in a case where the examination data deletion unit 12 deletes the examination data 37 of “Hanako Kimura” who is the specific individual because “Hanako Kimura” withdraws the provision of the information, the examination data deletion unit 12 deletes “Hanako Kimura” as the personal ID 35 and “ano002” as the first pseudonym ID 36 associated with “Hanako Kimura” in the pseudonym reverse lookup table, “ano002” as the specific first pseudonym ID 36 and “height: 158, body weight: 124, γGTP: 93, and the like” as the specific examination data 37 associated with “ano002” in the pseudonym examination table 32, and “ano002” as the specific first pseudonym ID 36 and “unknown002” as the specific second pseudonym ID 38 associated with “ano002” in the examination diagnosis reverse lookup table 33. As a result, the examination data 37 of the individual who withdraws the consent to provide information is deleted. In addition, the association between “obesity” as the diagnostic data 39 and “Hanako Kimura” as the personal ID 35 can be released, and “obesity” as the diagnostic data 39 can be anonymized and left such that “obesity” cannot be identified as data of “Hanako Kimura”.

In a process of deleting the specific examination data 37 via the examination data deletion unit 12, the diagnostic data specifying unit 13 stores the second pseudonym ID 38 corresponding to the examination data 37 to be deleted, and specifies the diagnostic data 39 associated with the deleted examination data 37 from the second pseudonym ID 38. In this case, the diagnostic data specifying unit 13 may have a duplicate of the examination diagnosis reverse lookup table 33. As a result, the diagnostic data 39 corresponding to the stored second pseudonym ID 38 can be easily obtained, but there is no data for specifying the individual, so that the safety can be maintained from the viewpoint of personal information protection.

As shown in FIG. 8, in a case where “unknown002” as the second pseudonym ID 38 is deleted, the diagnostic data specifying unit 13 stores the second pseudonym ID 38 and specifies the diagnostic data 39 associated with the second pseudonym ID 38 as “obesity” by referring to the duplicate of the examination diagnosis reverse lookup table 33.

The pseudo examination data generation unit 14 creates the pseudo examination data that is pseudo for the deleted examination data 37. In this case, it is preferable to calculate a reconstruction error in order to obtain the pseudo examination data that does not completely match the deleted examination data 37. That is, it is preferable that the pseudo examination data generation unit 14 calculates the reconstruction error indicating a rate of match between the deleted examination data 37 and the pseudo examination data, and the pseudo examination data generation model generates the pseudo examination data such that an absolute value of the reconstruction error is a positive number.

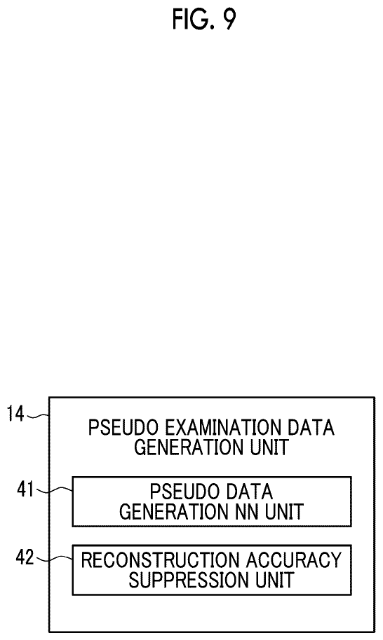

As shown in FIG. 9, the pseudo examination data generation unit 14 comprises a pseudo data generation neural network unit (hereinafter, referred to as a pseudo data generation NN unit) 41 and a reconstruction accuracy suppression unit 42. By comprising the reconstruction accuracy suppression unit 42, the pseudo data generation NN unit 41 outputs the pseudo examination data that is pseudo for the deleted examination data 37 and does not completely match the deleted examination data 37.

The pseudo data generation NN unit 41 is a trained model using a neural network model, and is trained to output pseudo examination data that is pseudo for the input examination data 37 of the individual, as output data 52, by receiving the input of the deleted examination data 37 of the individual and the deleted diagnostic data 39, as input data 51, from the examination data 37 in the pseudonym examination table 32 and the diagnostic data 39 in the pseudonym diagnosis table 34.

In a case where the trained model provided in the pseudo data generation NN unit 41 has high accuracy, the same data as the deleted examination data 37 may be reproduced. Therefore, it is preferable that the reconstruction accuracy suppression unit 42 optionally suppresses the reconstruction accuracy.

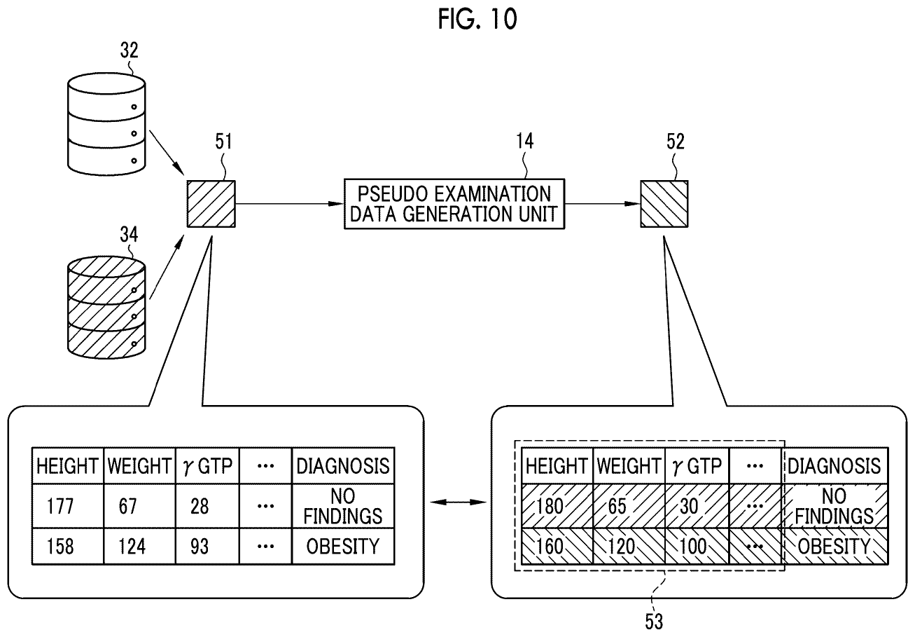

As shown in FIG. 10, the pseudo examination data generation unit 14 acquires, as the input data 51, two pieces of data of “height: 177, weight: 67, γGTP: 28, diagnosis: no findings” and “height: 158, weight: 124, γGTP: 93, diagnosis: obesity”, which are the deleted examination data 37 of the individual and the diagnostic data 39, from the examination data 37 in the pseudonym examination table 32 and the diagnostic data 39 in the pseudonym diagnosis table 34. The pseudo examination data generation unit 14 outputs the output data 52 by the pseudo data generation NN unit 41 and the reconstruction accuracy suppression unit 42. The output data is the pseudo examination data 53 of each of the two pieces of data.

The output data 52 is data output by associating “height: 180, weight: 65, γGTP: 30” as the pseudo examination data 53 with “diagnosis: no findings” as the diagnostic data 39, for “height: 177, weight: 67, γGTP: 28, diagnosis: no findings” as the input data 51. Similarly, the output data 52 is data output by associating “height: 160, weight: 120, γGTP: 100” as the pseudo examination data 53 with “diagnosis: obesity” as the diagnostic data 39, for “height: 158, weight: 124, γGTP: 93, diagnosis: obesity” as the input data 51.

The pseudo examination data 53 is not completely the same as the deleted examination data 37 included in the input data 51 and has the same feature as the deleted examination data 37. Since the pseudo examination data 53 has the same feature as the deleted examination data 37, in a case where the output pseudo examination data 53 is used as the training data for the learning model, the result or the like output by the trained model is not deteriorated as compared with a case where the deleted examination data 37 is used as the training data for the learning model. Therefore, in the training data including the pseudo examination data 53, the stability as the training data is maintained as compared with a case where the examination data 37 is not deleted.

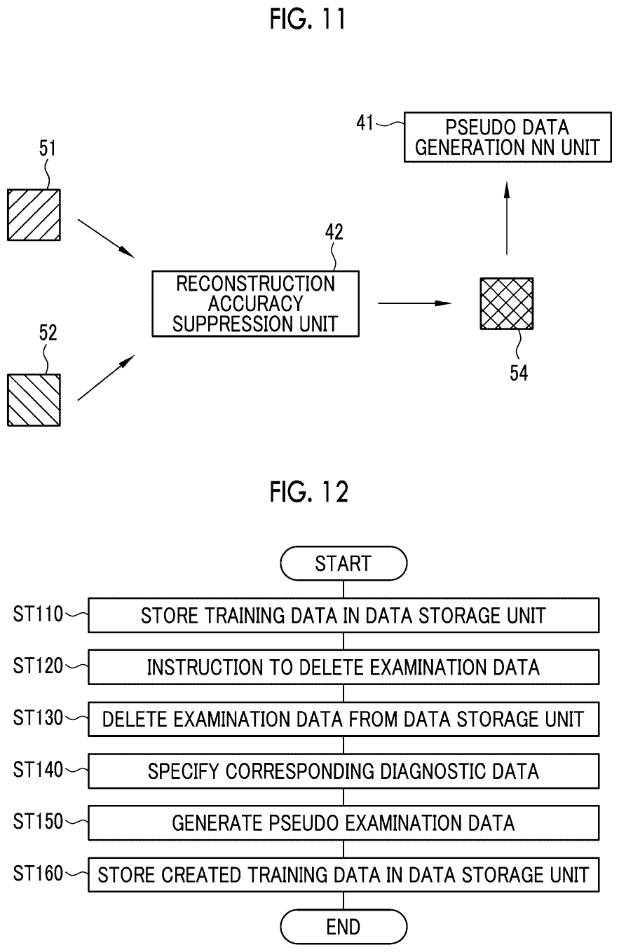

It should be noted that, as shown in FIG. 11, the reconstruction error calculated by the reconstruction accuracy suppression unit 42 is calculated from the input data 51 and the output data 52. Moreover, the calculated reconstruction error 54 is fed back to the pseudo data generation NN unit 41 in a case where the pseudo data generation NN unit 41 is trained. As a result, the pseudo data generation NN unit 41 can suitably output the deleted examination data 37 of the individual included in the input data 51 and the pseudo examination data 53 that does not completely match the deleted examination data 37 of the individual.

Any method may be used to calculate the reconstruction error 54 as long as an error between two data, the input data 51 and the output data 52, is calculated, but the reconstruction error 54 need only be a positive number, that is, the error need only not be zero. As a method of calculating the error between the two data, a generally used method, such as a mean absolute error (MAE), a mean squared error (MSE), or a root mean squared error (RMSE), can be adopted, in addition to an error by an absolute value of a simple difference. By adopting any method, the pseudo data generation NN unit 41 can be controlled such that the reconstruction error 54 is a positive number, that is, the error is not zero, and the input data 51 and the output data 52 can be prevented from matching.

It should be noted that, in a case where the reconstruction error 54 is a positive number but is a positive number that is too large, a difference between the deleted examination data 37 and the output pseudo examination data 53 is large, and there is a concern that the deleted examination data 37 and the output pseudo examination data 53 do not have the same feature, so that it is preferable that the reconstruction error 54 is equal to or smaller than a preset threshold value.

It should be noted that the pseudo examination data generation model itself may have a function of the reconstruction accuracy suppression unit 42. That is, the pseudo examination data generation model may be a model in which a generation model that generates the pseudo examination data 53 by receiving the input of the deleted examination data and the diagnostic data corresponding to the deleted examination data, and an evaluation model that evaluates the generated pseudo examination data 53 are connected to each other. Therefore, this configuration is preferable since the pseudo examination data generation model itself is prevented from outputting the output data 52 that completely matches the input data 51.

Examples of such a model include a generation model, such as conditional generative adversarial networks (conditional GAN) classified into a supervised learning model having a generator, which is the generation model, and a discriminator, which is the evaluation model, or conditional variational autoencoders (conditional VAE) classified into a supervised learning model. Through the training by applying the diagnostic data, which is the correct answer label, to the model having the generator and the discriminator, the input data 51 and the output data 52 can be evaluated to output the appropriate output data 52.

The pseudo examination data substitution unit 15 substitutes the training data in which the pseudo examination data 53, which is the output data 52, and the diagnostic data 39 are associated with each other with the training data including the deleted examination data 37, and stores the substituted training data in the data storage unit 11. In this case, the raw data, which is the examination data 37, and the pseudo examination data 53 may be distinguishable from each other for verification or the like in a case of the use as the training data. The pseudo examination data 53 can be labeled, the examination data 37 can be labeled, and the like.

It should be noted that, in the above-described embodiment, a part of the plurality of examination data 37 is described as the pseudo examination data 53, but all of the plurality of examination data 37 may be used as the pseudo examination data 53. In this case, not all the generated training data is the actually obtained examination data 37, but has the feature of the examination data 37, the safety is high from the viewpoint of personal information protection. Also, since the generated training data has the feature of the actually obtained examination data 37, the generated training data is highly valid as the training data and is excellent training data.

In a case where all the examination data is the pseudo examination data 53 for the training data managed by the training data management device 10, the training data managed by the training data management device 10 may be provided to a third party outside the medical institution from the medical institution to be available for various uses, assuming that the safety from the viewpoint of personal information protection is maintained. Therefore, with the training data management device 10, it is possible to provide useful training data.

Hereinafter, a flow of processing by the training data management device 10 will be described with reference to a flowchart shown in FIG. 12. In a case where consent is obtained for various uses for the examination data 37 obtained in a case where the individual gets the examination, the examination data 37 and the diagnostic data 39 generated by the doctor based on the examination data 37 are associated with each other, and are used as the training data. The training data is stored in the data storage unit 11 for training the learning model in machine learning (step ST110).

For example, in a case where the individual is specified by the examination data 37 of the individual himself/herself, the individual withdraws the consent to provide the information about the use of the examination data 37. In a case where the consent is withdrawn, for example, a hospital staff member or the like who performs the examination gives an instruction to delete the examination data stored in the data storage unit 11 from the client terminal 22 (see FIG. 2) (step ST120). The examination data deletion unit 12 deletes the examination data 37 from the data storage unit 11 based on the instruction (step ST130).

In a case where the examination data deletion unit 12 deletes the examination data 37, the diagnostic data specifying unit 13 obtains information about the examination data 37 to be deleted, and specifies the diagnostic data 39 corresponding to the deleted examination data (step ST140). In addition, the pseudo examination data generation unit 14 also obtains the information about the deleted examination data 37 and the information about the diagnostic data 39 corresponding to the deleted examination data 37, and generates the pseudo examination data 53 (step ST150). The pseudo examination data 53 may be generated in association with the diagnostic data 39.

The pseudo examination data substitution unit 15 creates the training data in which the pseudo examination data 53 and the diagnostic data 39 corresponding to the deleted examination data 37 are associated with each other, and stores the created training data in the data storage unit 11 instead of the training data including the deleted examination data 37.

In the above-described embodiment, hardware structures of processing units that execute various types of processing, such as the data storage unit 11, the examination data deletion unit 12, the diagnostic data specifying unit 13, the pseudo examination data generation unit 14, and the pseudo examination data substitution unit 15, are various processors as described below. The various processors include a central processing unit (CPU) that is a general-purpose processor that executes software (programs) to function as various processing units, a graphical processing unit (GPU), a programmable logic device (PLD) that is a processor capable of changing a circuit configuration after manufacture, such as a field programmable gate array (FPGA), and an exclusive electric circuit that is a processor having a circuit configuration exclusively designed to execute various types of processing.

One processing unit may be configured by one of these various processors, or may be configured by a combination of two or more processors of the same type or different types (for example, a plurality of FPGAs, a combination of a CPU and an FPGA, or a combination of a CPU and a GPU). Moreover, a plurality of processing units may be constituted by one processor. As an example in which the plurality of processing units are configured by one processor, first, there is a form in which one processor is configured by a combination of one or more CPUs and software, and this processor functions as the plurality of processing units, as represented by a computer, such as a client or a server. Second, there is a form in which a processor, which implements the functions of the entire system including the plurality of processing units with one integrated circuit (IC) chip, is used, as represented by a system on chip (SoC) or the like. As described above, various processing units are configured by one or more of the various processors described above, as the hardware structure.

Further, the hardware structure of these various processors is, more specifically, an electric circuit (circuitry) having a form in which circuit elements, such as semiconductor elements, are combined. In addition, the hardware structure of the storage unit is a storage device, such as a hard disc drive (HDD) or a solid state drive (SSD).

From the above description, the training data management device 10 described in supplementary notes 1 to 10 below can be understood.

### Supplementary Note 1

A training data management device comprising: a processor, in which the processor stores, in a data storage unit, training data in which examination data obtained from an examination got by an individual and diagnostic data generated based on the examination data are included in association with each other, deletes specific examination data from the data storage unit, specifies the diagnostic data associated with the deleted examination data, generates pseudo examination data, which is pseudo for the deleted examination data, based on the specified diagnostic data, and stores the pseudo examination data in the data storage unit in association with the specified diagnostic data.

### Supplementary Note 2

The training data management device according to supplementary note 1, in which the specific examination data is the examination data including a content indicating that consent to provide information is withdrawn from the individual.

### Supplementary Note 3

The training data management device according to supplementary note 1 or 2, in which the pseudo examination data is the examination data having the same feature as a feature of the deleted examination data.

### Supplementary Note 4

The training data management device according to any one of supplementary notes 1 to 3, in which the pseudo examination data is the examination data that does not completely match the deleted examination data.

### Supplementary Note 5

The training data management device according to any one of supplementary notes 1 to 4, in which the data storage unit associates a personal ID and the examination data of the individual who gets the examination with each other using a first pseudonym ID and associates the first pseudonym ID and the diagnostic data with each other using a second pseudonym ID, to store the training data in which the personal ID, the examination data, and the diagnostic data are included in association with each other.

### Supplementary Note 6

The training data management device according to supplementary note 5, in which the processor generates a pseudonym reverse lookup table consisting of the personal ID and the first pseudonym ID, a pseudonym examination table consisting of the first pseudonym ID and the examination data, an examination diagnosis reverse lookup table consisting of the first pseudonym ID and the second pseudonym ID, and a pseudonym diagnosis table consisting of the second pseudonym ID and the diagnostic data, and the data storage unit stores the pseudonym reverse lookup table, the pseudonym examination table, the examination diagnosis reverse lookup table, and the pseudonym diagnosis table in the data storage unit.

### Supplementary Note 7

The training data management device according to supplementary note 6, in which, in a case where the processor deletes the examination data of a specific individual from the data storage unit, the processor deletes the personal ID of the specific individual and a specific first pseudonym ID associated with the personal ID in the pseudonym reverse lookup table, the specific first pseudonym ID and specific examination data associated with the specific first pseudonym ID in the pseudonym examination table, and the specific first pseudonym ID and a specific second pseudonym ID associated with the specific first pseudonym ID in the examination diagnosis reverse lookup table.

### Supplementary Note 8

The training data management device according to any one of supplementary notes 1 to 7, in which the processor generates the pseudo examination data by using a pseudo examination data generation model, and the pseudo examination data generation model is a trained model that has been trained to generate the pseudo examination data by receiving input of the deleted examination data and the diagnostic data.

### Supplementary Note 9

The training data management device according to supplementary note 8, in which the processor calculates a reconstruction error indicating a rate of match between the deleted examination data and the pseudo examination data, and the pseudo examination data generation model generates the pseudo examination data such that an absolute value of the reconstruction error is a positive number.

### Supplementary Note 10

The training data management device according to supplementary note 8, in which the pseudo examination data generation model is a model in which a generation model that generates the pseudo examination data by receiving the input of the deleted examination data and the diagnostic data, and an evaluation model that evaluates the generated pseudo examination data are connected to each other.

### EXPLANATION OF REFERENCES

10: training data management device
11: data storage unit
12: examination data deletion unit
13: diagnostic data specifying unit
14: pseudo examination data generation unit
15: pseudo examination data substitution unit
20: medical treatment information management system
21: server group
22: client terminal
23: network
24: electronic medical record server
24A: medical record database
25: image server
25A: image database
26: report server
26A: report database
31: pseudonym reverse lookup table
32: pseudonym examination table
33: examination diagnosis reverse lookup table
34: pseudonym diagnosis table
35: personal ID
36: first pseudonym ID
37: examination data
38: second pseudonym ID
39: diagnostic data
41: pseudo data generation NN unit
42: reconstruction accuracy suppression unit
51: input data
52: output data
53: pseudo examination data
54: reconstruction error
ST110 to ST160: step

What is claimed is:

1. A training data management device comprising:
one or more processors configured to:
store, in a data storage, training data in which examination data obtained from an examination got by an individual and diagnostic data generated based on the examination data are included in association with each other;
delete specific examination data from the data storage;
specify the diagnostic data associated with the deleted examination data;
generate pseudo examination data, which is pseudo for the deleted examination data, based on the specified diagnostic data; and
store the pseudo examination data in the data storage in association with the specified diagnostic data.

2. The training data management device according to claim 1,
wherein the specific examination data is the examination data including a content indicating that consent to provide information is withdrawn from the individual.

3. The training data management device according to claim 1,
wherein the pseudo examination data is the examination data having the same feature as a feature of the deleted examination data.

4. The training data management device according to claim 1,
wherein the pseudo examination data is the examination data that does not completely match the deleted examination data.

5. The training data management device according to claim 1,
wherein the data storage stores the training data in which a personal ID of the individual who gets the examination is associated with the examination data using a first pseudonym ID, and the first pseudonym ID is associated with the diagnostic data using a second pseudonym ID, so that the personal ID, the examination data, and the diagnostic data are associated with each other.

6. The training data management device according to claim 5,
wherein the one or more processors are configured to generate:
a pseudonym reverse lookup table consisting of the personal ID and the first pseudonym ID;
a pseudonym examination table consisting of the first pseudonym ID and the examination data;
an examination diagnosis reverse lookup table consisting of the first pseudonym ID and the second pseudonym ID; and
a pseudonym diagnosis table consisting of the second pseudonym ID and the diagnostic data, and
the data storage stores the pseudonym reverse lookup table, the pseudonym examination table, the examination diagnosis reverse lookup table, and the pseudonym diagnosis table.

7. The training data management device according to claim 6,
wherein, the one or more processors are configured to delete, in a case of deleting the examination data of a specific individual from the data storage:
the personal ID of the specific individual and a specific first pseudonym ID associated with the personal ID in the pseudonym reverse lookup table;
the specific first pseudonym ID and specific examination data associated with the specific first pseudonym ID in the pseudonym examination table; and
the specific first pseudonym ID and a specific second pseudonym ID associated with the specific first pseudonym ID in the examination diagnosis reverse lookup table.

8. The training data management device according to claim 1,
wherein the one or more processors are configured to generate the pseudo examination data by using a pseudo examination data generation model, and
the pseudo examination data generation model is a trained model that has been trained to generate the pseudo examination data by receiving input of the deleted examination data and the diagnostic data.

9. The training data management device according to claim 8,
wherein the one or more processors are configured to calculate a reconstruction error indicating a rate of match between the deleted examination data and the pseudo examination data, and
the pseudo examination data generation model generates the pseudo examination data such that an absolute value of the reconstruction error is a positive number.

10. The training data management device according to claim 8,
wherein the pseudo examination data generation model is a model in which a generation model that generates the pseudo examination data by receiving the input of the deleted examination data and the diagnostic data, and an evaluation model that evaluates the generated pseudo examination data are connected to each other.

11. A training data management method comprising:
a step of storing, in a data storage, training data in which examination data and diagnostic data generated based on the examination data are included in association with each other;
a step of deleting specific examination data from the data storage;
a step of specifying the diagnostic data associated with the deleted examination data;
a step of generating pseudo examination data, which is pseudo for the deleted examination data, based on the specified diagnostic data; and
a step of storing the pseudo examination data in the data storage in association with the specified diagnostic data.

12. A non-transitory computer readable medium for storing a computer-executable program, the computer-executable program causing a computer to execute:
a function of storing, in a data storage, training data in which examination data and diagnostic data generated based on the examination data are included in association with each other;
a function of deleting specific examination data from the data storage;
a function of specifying the diagnostic data associated with the deleted examination data;
a function of generating pseudo examination data, which is pseudo for the deleted examination data, based on the specified diagnostic data; and
a function of storing the pseudo examination data in the data storage in association with the specified diagnostic data.
